(19) United States
(12) Patent Application Publication
(10) Pub. No.: US 2022/0292474 A1
(43) Pub. Date: Sep. 15, 2022

(54) Payment Processing of Medical Services

(71) Applicant: Stephanie Littell, Lexington, MA (US)

(72) Inventor: Stephanie Littell, Lexington, MA (US)

(21) Appl. No.: 17/654,522

(22) Filed: Mar. 11, 2022

Related U.S. Application Data
(60) Provisional application No. 63/160,510, filed on Mar. 12, 2021.

(51) Int. Cl. G06Q 20/14; G06Q 20/40; G06Q 40/08

(52) U.S. Cl. CPC G06Q 20/14; G06Q 20/4016; G06Q 40/08

(57) ABSTRACT

Payments for administration of health care are processed via a network linking the patients, providers, employers and insurers. A notification of a health care service administered to a patient identifies an expense associated with the health care service. The expense is adjusted by a fee derived from a base and/or one or more percentages via an insurance plan parameter. Based on the expense and a parameter defined by the patient's insurance plan, a division of the expense among a patient account and an employer account is automatically determined, resulting in a patient portion of the adjusted expense and an employer portion. A representation of a patient bill, indicating the patient portion, is then transmitted to a patient device. The patient account is then automatically updated in response to receipt of payment of the patient portion indicated on the patient bill.

### RELATED APPLICATION

This application claims the benefit of U.S. Provisional Application No. 63/160,510, filed on Mar. 12, 2021. The entire teachings of the above application are incorporated herein by reference.

### BACKGROUND

Health care in the United States is provided and financed by many different organizations, including insurance companies, hospital systems, and independent healthcare providers. Health care facilities are largely owned and operated by non-profit and for-profit private sector businesses. In contrast to many other countries, the United States does not have a universal healthcare program. Instead, health care is financed through a combination of private health insurance and public health coverage, such as Medicare and Medicaid.

Most Americans with private health insurance receive it through an employer-sponsored program, while others purchase it as individual consumers. In employer-sponsored programs, an employer typically pays for most of the insurance premium for their employees, while the remainder is paid by the employees, often with pre-tax or tax-exempt earnings. Thus, payment of health care services under private insurance typically requires coordination and communication between the patient, health care provider, and insurer, as well as an employer under employer-sponsored programs.

### SUMMARY

Example embodiments include computer-implemented methods of processing a payment for administration of health care. A notification of a health care service administered to a patient may be parsed by a digital processor, the notification identifying the patient and at least one expense associated with the health care service. The expense may be adjusted by a fee derived from a base and/or one or more percentages via an insurance plan parameter, the adjusting being responsively performed by the digital processor. Based on the at least one expense and on a parameter defined by the patient's insurance plan, a division of the at least one expense among a patient account and an employer account may be automatically determined, results of said determining including a patient portion of the at least one adjusted expense and an employer portion. A representation of a patient bill may then be transmitted by a server to a patient device, the patient bill indicating the patient portion resulting from the determined division of the at least one adjusted expense. The patient account may then be automatically updated in response to receipt of payment of the patient portion indicated on the patient bill.

The division of the at least one expense may be a function of a risk allocation parameter. Updating the patient account may be automatically reconciled via an electronic pay request and authorization procedure. The division may be determined as a function of patient risk factors including at least one of credit history, income, and underlying health conditions of the patient.

Based on the at least one expense and on a parameter defined by the patient's insurance plan, a three-way division of the at least one expense among a patient account, an employer account, and an insurer account may be automatically determined. A representation of an employer bill may be automatically transmitted to an employer device, the employer bill indicating the employer portion resulting from the determined division of the at least one adjusted expense.

The employer account may be automatically updated in response to receipt of payment of the employer portion via the employer's payment processor or gateway. A distributed order of transactions may be opened across patient, employer, provider and insurer devices and accounts, and the local transactions across multiple repositories may be globally coordinated.

A representation of the patient bill may be automatically transmitted to an insurer device, the patient bill indicating the patient portion resulting from the determined division of the at least one adjusted expense. An insurer account may be automatically updated in response to receipt of payment of any insurer portion resulting from the determined division of the at least one adjusted expense via the insurer's payment processor or gateway. The provider account may be automatically updated, via a payment processor or gateway, to indicate a payment by at least one of the employer and an insurer. Global coordination may be closed with successful commits, or rolling back all or some transactions.

The payment of the patient portion of the patient bill may be made via the patient device. Access to the patient account may be enabled via the employer account, and the payment of the patient portion of the patient bill may be via an employer device. The payment of the patient portion of the patient bill may include withdrawing funds from an allowance account funded by the employer account.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a block diagram of a network in which example embodiments may be implemented.

FIG. 2 is a block diagram of a server configured to process payments in one embodiment.

FIG. 3 is a flow diagram of a method of processing a health care expense in one embodiment.

FIG. 4 is a table illustrating example account data in one embodiment.

FIG. 5 is a table illustrating example insurance parameter data in one embodiment.

FIG. 6 is a flow chart illustrating calculation of a fee in one embodiment.

FIG. 7 is a flow chart illustrating determination of a fee based on a risk assessment in one embodiment.

FIG. 8 is a flow diagram illustrating initial processing of a service notification in one embodiment.

FIG. 9 is a flow diagram illustrating further processing of a service notification in one embodiment.

FIG. 10 is a flow diagram illustrating communication to support an outgoing bill in one embodiment.

FIG. 11 is a state diagram of a billing process in one embodiment.

FIG. 12 is a flow diagram illustrating communication among parties during processing of a bill for health care services in one embodiment.

FIG. 13 is a block diagram of a network in which example embodiments may be implemented.

FIG. 14 is a state diagram of a process of bill initiation and settlement in one embodiment.

FIG. 15 is a state diagram of a process of bill initiation and employer-stationed settlement in one embodiment.

FIG. 16 is a state diagram of a process of bill initiation and pool-stationed settlement in one embodiment.

FIG. 17 is a diagram of a computer network in which example embodiments may be implemented.

FIG. 18 is a diagram of a computer that may be configured in accordance with an example embodiment.

### DETAILED DESCRIPTION

A description of example embodiments follows.

The costs of private health insurance in the United States have been rising rapidly, far outpacing the rate of inflation. One factor responsible for this increase is the cost incurred by healthcare insurers. Typical healthcare insurance requires substantial labor and time throughout the process. To enable payment for healthcare service rendered as a bill, a provider often staffs up department and back-end clerical labor. To match incurred health service claims to an insurance contract's authorization and settling, an insurer often staffs up clerical claims workers. To handle service issues arising over claims vs authorization, a patient/beneficiary sometimes labors to clarify or research with insurance workers. Due to these steps, provider collection remittals are costly and lag on average by well over a month. Thus, the labor and resources required for payment of health care add up to ongoing, real healthcare costs that are absorbed by everyone, yet fail to provide corresponding value to the patient.

In contrast, example embodiments, described below, provide an automated insurer system and process that automate and accelerate the process of billing, claims, and settling of health care payments. Today's healthcare insurance also requires recurring upfront premiums, in exchange for coverage limits detailed by medical specialty and carveouts. Example embodiments may instead enable a pay-as-needed system in place of upfront financial premiums, and may dispense with today's varying web of specialty coverage and carveouts, over time accumulating sufficient funds by scaling across automated processes.

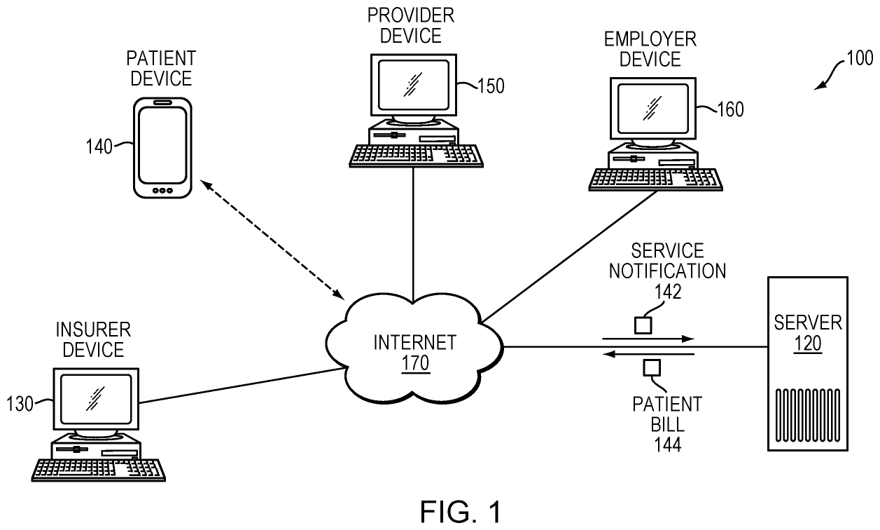

FIG. 1 is a block diagram of a network 100 in which example embodiments may be implemented. The network 100 may communicatively link a number of parties involved in payment of health care services, including patients, health care providers, insurers, and employers participating in health care coverage of their employees. FIG. 1 shows an abbreviated view of the network 100 that depicts the devices that may be involved in the processing of an example health care payment. In particular, a health care insurer device 130, a patient device 140, a health care provider device 150, and an employer device 160 may each be configured to communicate with a server 120 across the Internet 170 and/or another network. Alternatively, one or more of the parties and their devices may be omitted from the network 100. The devices 130, 140, 150, 160 may each comprise one or more computing devices configured to communicate with the server 120 via wired and/or wireless channels across the Internet 170, such as a smartphone, a computer workstation, a tablet, a server, and an Internet of Things (IoT) device. The server 120 may be managed or operated by the provider, insurer, employer, or another party authorized to process payments for health care services.

To initiate processing a payment for administration of health care, one or more of the networked devices (e.g., the provider device 150 or the insurer device 130) may transmit a service notification 142 to the server 120 indicating a health care service administered to a patient. The server 120 may then process the notification to determine a division among the parties of the expenses corresponding to the services rendered, as described in further detail below. The server 120 may generate a patient bill 144 in accordance with this division, and transmit the patient bill 144 to the patient device 140 for review and payment by the patient. The patient bill 144 or a corresponding document may also be transmitted to one or more of the insurer device 130, provider device 150, and employer device 160. Thus, through the network 100, a distributed order of transactions may be opened across patient, employer, provider and insurer devices and accounts, and the local transactions across multiple repositories may be globally coordinated.

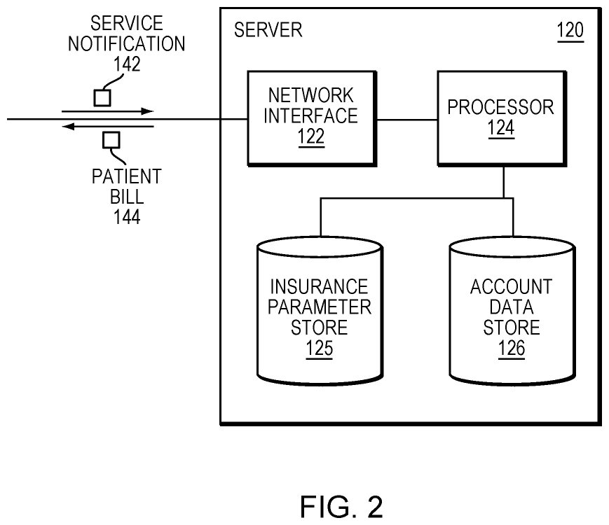

FIG. 2 illustrates the server 120 in further detail. The server 120 may include a network interface 122 for communicating with the devices 130, 140, 150, 160 and the Internet 170 and receiving the service notification 142. A digital processor 124 may access account data and insurance parameters corresponding to the service notification 142 from an account data store 126 and an insurance parameter store 125, respectively. The processor 124 may also perform processing of the service notification 142, as described below, to produce the patient bill 144 and update the account data store 126 and/or the insurance parameter store 125, accordingly.

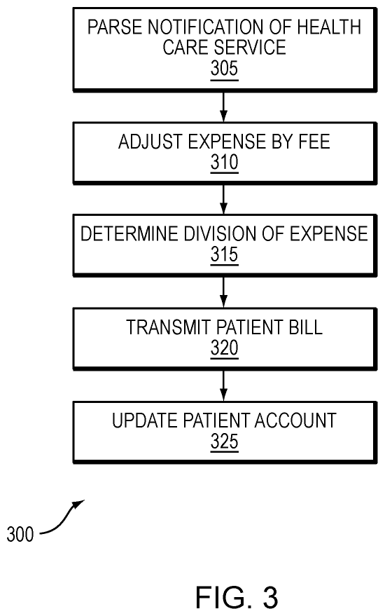

FIG. 3 illustrates a method 300 of processing a health care expense in an example embodiment. The method 300 may be performed, for example, by the server 120 in communication with the network 100 described above. With reference to FIGS. 1 and 2, the server 120 may receive, via the network interface 122, a service notification 142 indicating a health care service administered to a patient. The service notification 142 may be issued by the health care provider or insurer via corresponding devices 130, 150. The digital processor 124 may parse the notification to identify the patient that received the service and at least one expense associated with the health care service (305). The processor 124 may then adjust the expense by a fee derived from a base and/or one or more percentages via an insurance plan parameter accessed from the insurance parameter store 125 (310). Based on the at least one expense and on a parameter defined by the patient's insurance plan identified from the account data store 126, the processor 124 may then determine a division of the at least one expense among a patient account and an employer account, resulting in a patient portion of the at least one adjusted expense and an employer portion (315). The division of the expense may be a function of a risk allocation parameter and/or may be determined as a function of patient risk factors including at least one of credit history, income, and underlying health conditions of the patient. Based on the expense and on a parameter defined by the patient's insurance plan, a three-way division of the at least one expense among a patient account, an employer account, and an insurer account may be automatically determined.

The processor 124 may generate a representation of a patient bill 144 and cause the patient bill 144 to be transmitted by the server 120 to the patient device 140 (320). The patient bill 144 may indicate the patient portion resulting from the determined division of the at least one adjusted expense. The server 120 may also transmit a representation of the patient bill 144 to the insurer device 130. Further, the processor 124 may also generate and transmit a representation of an employer bill to the employer device 160, the employer bill indicating the employer portion resulting from the determined division of the adjusted expense.

The patient may review the patient bill 144 at the patient device 140. For example, the patient device 140 may operate an application (e.g. a billing and/or integrated health care service software program) configured to communicate with the server 120 to facilitate review and payment of patient bills. Thus, in some embodiments, the patient may review and pay the patient bill 144 via the patient device 140. Optionally, the patient may pay the patient portion of the patient bill by withdrawing funds from an allowance account funded by the employer account, as indicated by the corresponding account data stored at the account data store 126. A confirmation of receipt of payment (e.g., by the provider or insurer via their respective devices 130, 150) may be transmitted to the server 120 to indicate that the patient has paid the patient portion of the patient bill 144. Accordingly, the processor 124 may automatically update the patient account (stored at the account data store 126) to indicate receipt of payment of the patient portion by the patient (325). Thus, updating the patient account may be automatically reconciled via an electronic pay request and authorization procedure. Optionally, the server 120 may enable access to the patient account via the employer account (e.g., via employer device 160), and the payment of the patient portion of the patient bill may be made through the employer device 160.

Likewise, for an employer bill, the server 120 may update an employer account stored at the account data store in response to receipt of payment of the employer portion via the employer's payment processor or gateway (e.g., employer device 160). Further, the server 120 may update an insurer account in response to receipt of payment of any insurer portion resulting from the determined division of the at least one adjusted expense via the insurer's payment processor or gateway (e.g., insurer device 130). The server 120 may also update a provider account, via a payment processor or gateway, to indicate a payment by at least one of the employer and an insurer. Thus, the server 120 may manage global coordination across the network 100 to close settlement of a bill with successful commits or, in the case of an error, rolling back some or all of the transactions between nodes of the network 100.

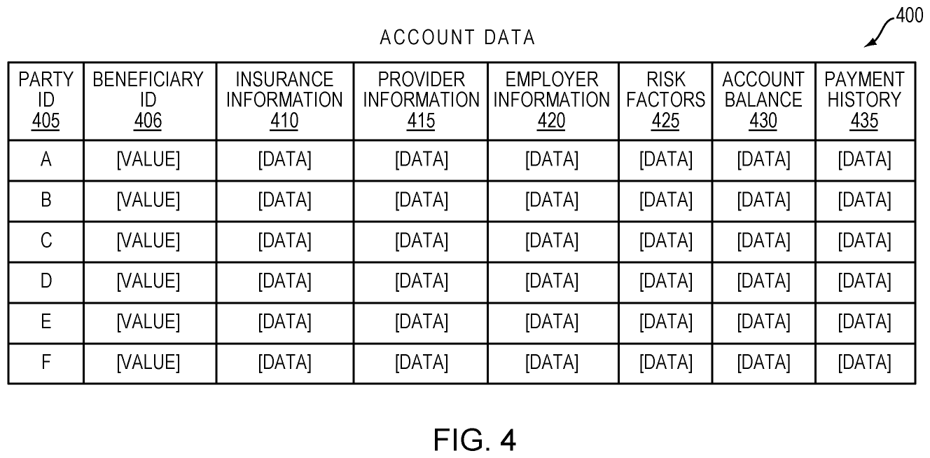

FIG. 4 is a table 400 illustrating example account data that may be stored at the account data store 126. Each entry of the table 400 may correspond to a given party (e.g., patient, insurer, provider, or employer), and includes several fields storing data about the party's account. Some fields may only be relevant to an entry if the entry is for a patient or employer, and may otherwise be omitted or left blank. As shown for example, the table 400 includes the following fields per entry:

a) A party identifier (ID) field 405 identifying the party associated with the entry.
b) A beneficiary ID field 406 identifying a beneficiary of an associated health insurance policy, wherein the patient may be a family member of the beneficiary.
c) An insurance information field 410 identifying one or more insurance plans associated with the party, if the party is a patient or employer.
d) A provider information field 415 identifying one or more health care providers used by the party, if the party is a patient.
e) An employer information field 420 identifying an employer and/or an employer-funded insurance plan associated with the party, if the party is a patient.
f) A risk factors field 425 identifying certain risk factors associated with the party, if the party is a patient (described in further detail below).
g) An account balance field 430 indicating an amount owed by the party, if the party is a patient or employer (which may be segmented by a number of given bills) and/or a positive balance available for spending on health care services. The field may be denoted to indicate a positive or negative balance (e.g., via parentheses or a “−” sign).
h) A payment history field 435 indicating payment history of the patient or employer, which may indicate the payment and/or nonpayment of given patient bills and associated dates.

Although the table 400 illustrates the aforementioned fields, further embodiments may omit one or more of the fields, or may include additional fields to store data about the patient, the employer, and/or health insurance associated with the patient. While the table 400 as shown may accommodate multiple different types of parties, the account data may instead be divided into separate tables or databases that each correspond to a given party type (e.g., patient, employer, insurer, provider).

In response to action or inaction by the patient, or notification by the insurer, patient, provider or employer via their corresponding devices 130, 140, 150, 160, the server 120 may update a patient's account data stored at the account data store 126. For example, in response to an indication that the patient has transitioned to a different insurance plan or employer, the server 120 may update the insurance information 410 or employer information 420 associated with the patient. Further, in response to an indication of payment of a patient bill 144, the server 120 may update the account balance 430 and/or payment history 435 associated with the patient.

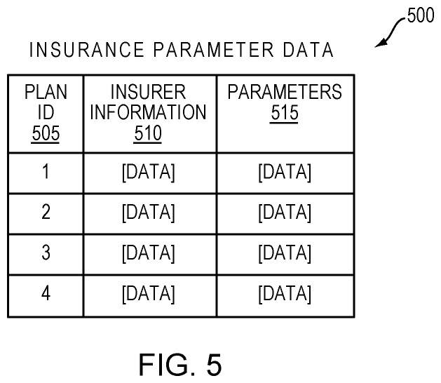

FIG. 5 is a table 500 illustrating example insurance parameter data that may be stored at the insurance parameter store 125. Each entry of the table 500 may correspond to a given insurance plan or given configuration of an insurance plan, which may be cross-referenced in the account data shown in FIG. 4 to associate patients and/or other parties with the insurance plan. Each entry may include a number of fields storing data about the insurance plan. As shown for example, the table 500 includes the following fields per entry:

a) A plan ID 505 identifying a given insurance plan associated with the entry.
b) Insurer information 510 indicating an insurer associated with the given insurance plan.
c) One or more insurance plan parameters 515 associated with the insurance plan.

When processing a patient bill or other bill, the server 120 may access the insurance parameter store 125 to look up one or more insurance plan parameters for the insurance plan associated with the bill. As described below, the insurance plan parameters may be used in example embodiments to determine a division of bills among the involved parties including one or more of the patient, employer and insurer.

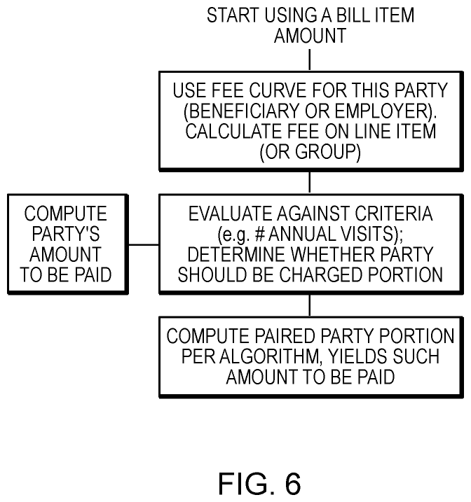

FIGS. 6-16, and the accompanying description below, describe example embodiments in further detail. The embodiments and components described above, including the network 100 and server 120, may be configured to operate as the embodiments described below.

FIG. 6 is a flow chart illustrating a conceptual order for calculating a fee to arise on behalf of a paired beneficiary and/or employer. If credit risk issues manifest with either party, a credit surcharge may be attributed there as an additional percentage fee (due if not paid in time, e.g. within 30 days). Ideally the beneficiary portion is only triggered in exceptional cases beyond a first allotted number of visits, as above. It may be constant, for simplicity. But, as amounts increase, it is harder for the beneficiary than the corporation to pay large absolute amounts. Thus, that portion may alter linearly or in steps, by a summed amount of designated transactions and/or cumulatively in amount.

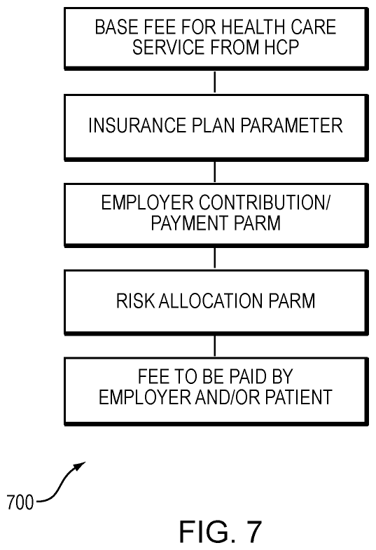

FIG. 7 is a flow chart illustrating a process 700 for determination of a fee based on a risk assessment in one embodiment. Risk issues can be broadly generalized as business or medical in this sector. Business risk includes credit risk and choices around spending money, such as how many/what kind of visits to a healthcare provider, as described above.

Medical risk includes diseases/conditions beyond one's control, and lifestyle diseases brought on by personal choice. Once condition is diagnosed/known, current and forward packaging of likely services for that disease can be projected. “Lifestyle” diseases may be expensed more to the beneficiary, than for other types (e.g., lung cancer brought on by smoking, vs lung cancer with no discernible lifestyle trigger). Risk allocation can be weighted blend of these factors.

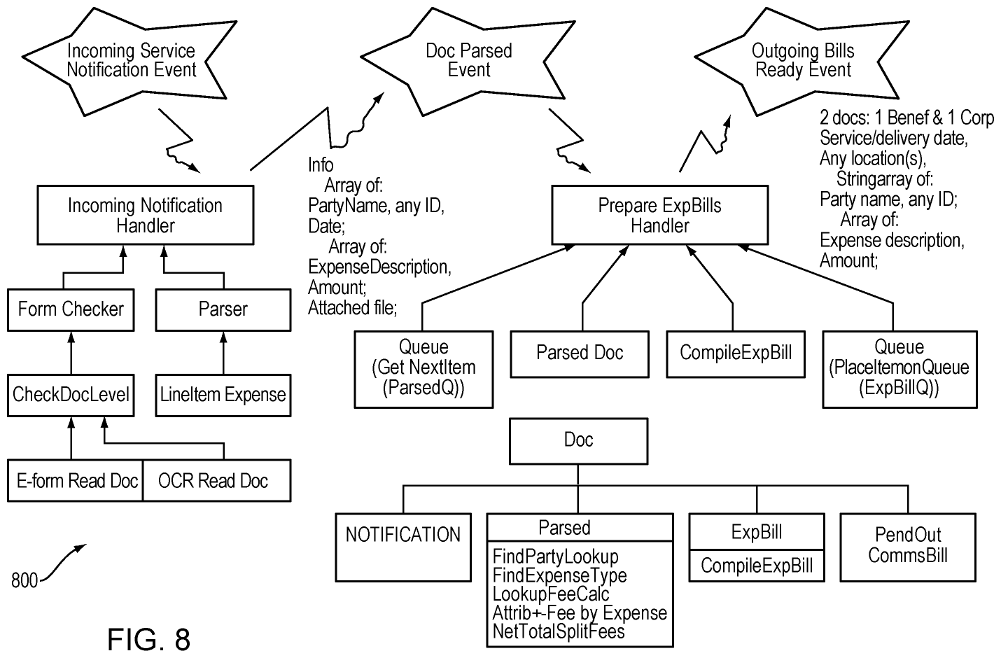

FIG. 8 is a flow diagram illustrating an example process 800 for initial processing of a service notification in one embodiment, and depicts high-level logical processing for the first few steps of incoming service notifications. For an incoming service notification event, an “Incoming Service Notification Handler” receives this event, performs the collective work of FormChecker object via verifying service doc existence and legitimacy, then parsing its contents via using electronic-form or OCR reading objects. The incoming file is of unknown format but presumed to be from a valid source in order to have successfully reached the Incoming Service Notification queue. File format starts as String format, to be parsed into header stream contents, internal content, and any end communications stream type(s).

The Parser object invokes a LineItem object to read string contents line by line. Information retrieved and placed into the ParsedDoc data structure includes:
Array [String [ExtractPartyName];
   String [anyID];
];
Array [String [ExtractExpenseDescription];
Currency [amount];
   ];

Retrieved service/delivery date(s), any location(s), and the attached original file are also included. To make it more scalable, once the parsed content results are prepared, an internal DocParsed event generates. Alternatively, for less scalability, the Incoming Service Notification Handler may be directly invoked by the next handler. The ParsedDoc is placed on the ParsedQueue.

The prepareExpBills Handler is cued to receive this event, and the Queue object subclassed for the parsed doc fetches from the event queue FIFO.

To scale across multiple providers, beneficiaries and employers, with one insurer, example embodiments may be configured to avoid bottlenecks. If bills are prepared together, then table updates may be configured to occur locally. Preparing bills at each participating provider balances the need for traffic minimization while scaling providers.

The ParsedDoc class reads parsed doc's PartyName string (and any accompanying ID) in FindPartyLookup, which identifies a Beneficiary if it exists. (The previous doc parsing prepared line items of expenses as well, and any specialty, department, or date-driven groupings.) Expenses are used to lookup the type, via FindExpenseType.

Using the identified expense type, for this beneficiary party, a line item corresponding fee (or fee equal to zero) is attributed via LookupFeeCalc to calculate the fee curve against the expense amount. A fee algorithm builds from a base currency or percentage (expense) amount, and one or more percentages or currency amounts may be added to that base by expense type or subtype. (Also, fee(s) may be waived or altered by a number of previous specialty visits this insurer or corporate fiscal or calendar year, corporation, division or group type, trial period, beneficiary type, cumulative paid amounts, cumulative corporate amounts, floor, max, additional base and/or one or more percentages, in a different currency)

Then if there is a paired corporation associated with the patient, corporate processing is invoked with the same expense type (as occasionally the division split may vary by type as well as corporation) and by referencing the patient's plan parameter (ie. metric specifics) in performing SplitFeebyType. Both beneficiary and corporate processing execute Attrib+−FeebyExpense (as some may be added, others subtracted), then NetTotalSplit Fees for each. (Later, such respective beneficiary/corporate split fees will be updated to respective accounts at the insurer following communications and debit results confirmed back.)

CompileExpBill rearranges the retrieved expense and splits the information by beneficiary and/or corporation respectively. (Each may or may not include a portion and/or copy of the original notice, or a reference to it) As per the shaded box in FIG. 8, the outgoing bill's basic content may include as-of-prepared/service date, service location, patient name, beneficiary name, this insurer name, and by:

a) expense type: expense service/supply, provider name, service date, expense amount, fee (or expense net fee), other corporate party's amount and fee responsibility (or net), total due.
b) Expense or type subcategories and an online bill pay code may also be utilized.

Once done, an OutgoingBillReady event is generated for the beneficiary and paired corporation respectively. (Also, a pending debit proviso may be placed on beneficiary or beneficiary/corporate accounts while in process, such that any further debit requests may factor in liability).

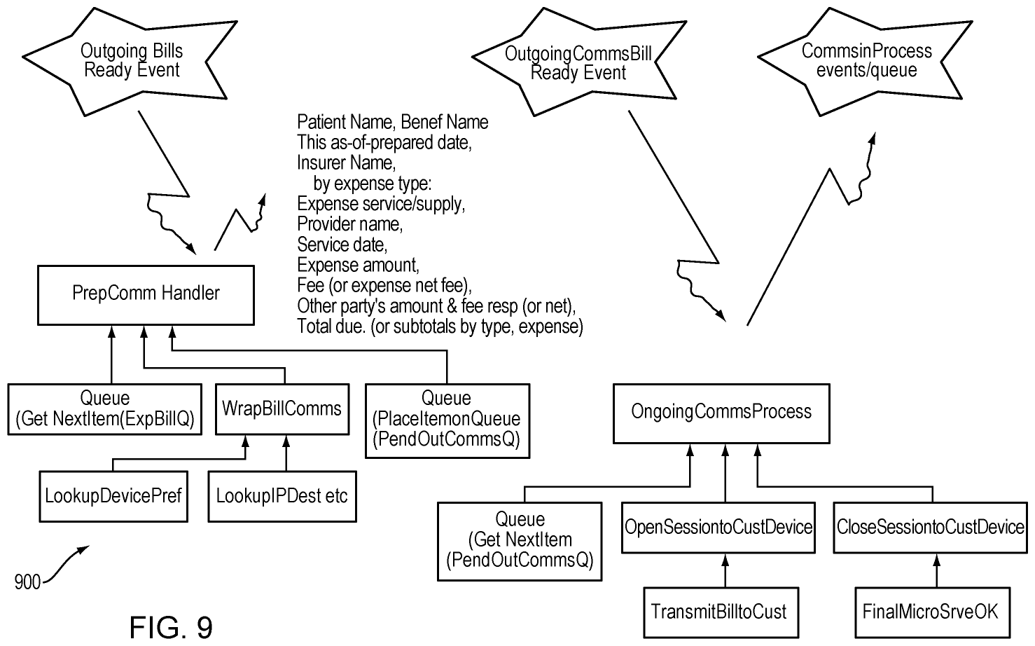

FIG. 9 is a flow diagram illustrating an example process 900 for high-level logical processing for the first few steps of transmitting a prepared bill. A PrepCommHandler receives the OutgoingBillReady event, and proceeds to wrap the bill via WrapBillComms. Such an object invokes Lookup to find the patient's preferred device, and other tables for related communications information such as IP destination and routing stream type. As per the shaded box in FIG. 9, the outgoing communications-wrapped bill may include various information. Once the communications header and other wrapper components are placed, the prepared OutgoingCommsBill is queued and an OutgoingCommsBillReady event generates.

An ongoing separate communications start process will use any pending communications-ready bills in the OutgoingCommsBill queue. A layered communications approach entails opening a session or stream via OpenSessiontoCustDevice, respectively using TransmitBilltoCust object.

If a successful transmittal result, subsequently a communications close process will mirror to close, via CloseSessiontoCustDevice. Result codes are returned from each object layer in the overall communications process, such that content results can be processed accordingly.

If a successful confirmation of a beneficiary debit is returned, the insurer's beneficiary account corresponding to the patient may also be updated. Queuing status and rate performance management may be implemented for administrative inquiries, as well as profiling in time and bottlenecking identification.

A health care service is work performed by provider(s) on behalf of a patient, e.g., surgeries and all accordingly-billed items.

Other expenses may include:

a) drugs and medications;
b) tests e.g. diagnostics e.g. hearing test, MRI;
c) procedures e.g. orthopedic forearm elongation/reduction;
d) healthcare services e.g. kidney dialysis, chemotherapy, radiation therapy;
e) rehabilitation and all accordingly-billed items;
f) nursing, hospice, personnel care,
g) medical equipment supplied e.g. dentures, hearing aids, glasses, contacts;
h) transportation to/from provider;
i) at-home visits;
j) healthcare-associated meals;
k) indirect services for a patient e.g. radiological reading.
l) all items billed to or incurred on behalf of a patient e.g. direct and indirect costs as is common billing practice. e.g. lighting, electrical, equipment usage, labor, floorspace overhead attributed.

The fee base can be a currency amount or percentage. It can be tiered (e.g., if a service or supply or a mix, there might be a differing base for each type and range amount). It can be in a different currency than the billed expenses, e.g., USD for home office vs services in GBP. The fee base may exhibit one or more of the following properties:

a) Can be detailed by in-house service type, or telehealth service type, or supplies, or mix.
b) Can be delineated by specialty, or sub-specialty, or mix.
c) Can be delineated by a recurring property in time, or one-time, or by a defined number, or by a retroactive change to recurrence.
d) Can be conditional, e.g. if >3 visits/mo to this provider, waive or partially attribute.
e) Can be negative, i.e. act as a credit.
f) Can be delineated by preventive, or resolving-type attribution, or mix.
g) Can be delineated by corporate class (e.g. corporate size, geographical region) or by provider class (e.g. specialties, size, region)

The fee percentage calculation can be tiered, and/or with a differing base for each (service, supply or mix) type and range amount. Each of the fee percentages may exhibit one or more of the following properties:

a) It can be in a different currency than the base.
b) Can be detailed by in-house service type, or telehealth service type, or supplies, or a mix of each.
c) Can be delineated by specialty, or sub-specialty, or mix.
d) Can be delineated by a recurring property in time, or one-time, or defined number, or by a retroactive change to recurrence.
e) Can be conditional, e.g. if >3 visits/mo to this provider, waive or partially attribute.
f) Can be negative, i.e. act as a credit.
g) Can be delineated by preventive, or resolving-type attribution, or mix.
h) Can be delineated by corporate class (e.g. corporate size, region) or by provider class (e.g. specialties, size, region)

The insurance plan parameter can be an array of vectors or a pointer to a data structure of patient metrics. Since metrics might include a n-dimensional assessment of one body “specialty” (e.g. heart overview as in cardiology), a m-dimensional assessment of another specialty (e.g. brain memory as in neurology). Each array element can encode a respective evaluation.

Such services may be packaged to other existing insurance systems via receiving an external inquiry that includes a beneficiary's first/middle/last names, birthdate, current address and other identifying data, and required/pertinent medical digital diagnostic files for evaluation. Other insurers can be asked to supply their customer list for a direct emailing of a downloadable cell or device application, for that insurance provider's beneficiaries to utilize, that will a) package such data directly to this insurer, and b) furnish an evaluated metric back to that insurance's provider. Alternatively, a website may be made available for such.

Such may be packaged as an “Express” version of a more general application, streamlined in order to free from user learning costs, and control against user error. Alternatively, an insurer-supplied form may solicit specific formats, including a minimum number of seconds of cell phone or device app readings (per other patents) for cardiac, brain or other services.

Insurers can compare the new (specialty) metric to the former obtained, through a downloadable insurer-level “evaluation” application that constitutes a supplied vector distance algorithm, executable, and visualizer in a supplied-network “stub” environment, or more broadly can be run on a general host system. Such an Evaluator application assesses how much healthcare value was provided in such period.

Such an evaluation application visualizer may also visually display or print a reduced-from n-dimensional space diagram of such metric difference and classification, for insurer and user comprehension. It may also showcase visually the current metric compared to typical or average, as an option. The application may include insurer's newly assigned beneficiary identifier ID, completion-evaluated insurance plan parameter, and corresponding as-of evaluation date. Through user locator data supplied by an earlier download, some of these prepared results may also be forwarded directly to their beneficiary, so that data may not be buried by that insurer.

Division of the patient's expense can be fixed, or variable. Any default fixed structure can be changed through: corporate, group pool, (rarely individual) re-negotiation, if a secondary employer with healthcare coverage is added for a beneficiary party, if the employer were to change, or if monetary threshold payouts were exceeded for a given period. A fixed expense division can also be changed through less or more than a designated number of visits per specialty in a year. A division rule can vary by specialty, or by provider type, or by program (e.g. starting trial period), or by compensation level (e.g. lower paid workers paying less), or by geographic employment status (e.g. a high-cost region)

A division rule may involve thresholding, where a given threshold may vary by employer, group, and/or pool plan. If the expense magnitude were to exceed such threshold, an insurer contributory percentage may be added for that time period's remainder, such that insurer contributes the beneficiary's remaining portion (presuming hardship for the beneficiary to pay past his portion), or a sliding scale commences for the beneficiary where insurer picks up an increment (and the corporate percentage remains unchanged).

A division adjustment “credit” percentage or amount to the individual may also occur if a desirable healthy lifestyle choice is honored for the time period, (e.g., avoiding smoking). Thus, the insurer absorbs the adjusted credit percentage or amount for such time period; review to re-occur at the period's beginning, end, or middle. If then a given cost limit is exceeded, the insurer may contribute at the beneficiary's adjusted portion, as lifestyle choices may not achieve enough of sought healthiness, and may discourage the beneficiary and corporate parties if one of them were to absorb.

Any type of “credit” to an individual can be passed along to family members, via an expense rule option. An expense rule adjustment “credit” to the family may also occur if a desirable healthy lifestyle choice is honored for the time period, e.g., exercising or healthy weight levels.

Transmission means for the patient bill occurs via software at the provider. The provider's system triggers transmission as bill preparation is completed there. Likely a dedicated application (downloadable from this insurer) arrayed with privacy controls, includes some application-level control which can invoke via “Send” command or occur automatically.

The payment system network may interface with frequent sampled batch input to designated directories or bill information coming from other specialty medical departments with existing practices, or at smaller providers it may support service notification and/or bill creation directly in a form-filling editor. Batch input and sweep provides an audit trail and can be read via OCR to minimize conversion issues. Over time, form-filled batch input can be mandated as leverage increases. Transmission of the bill may involve invoking a proxy server thread, and packing the bill header, footer or wrappers with the thread's return address.

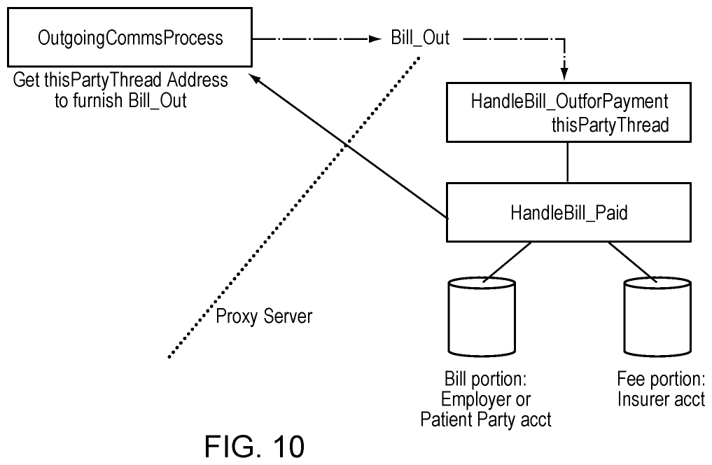

FIG. 10 is a flow diagram illustrating interplay for the bill's outgoing communication process and node server, via a thread. OutgoingCommsProcess shows the outgoing transmission of a prepared bill to the employer or beneficiary.

HandleBill_OutforPayment, at the node server, processes the returned bill that was previously sent out for payment. Among other return conditions, if the bill was successfully paid then HandleBill_Paid processes accordingly. It directs the bill portion to be debited on behalf of the party account in such a datastore, and the fee portion to be credited to the insurer account in a datastore.

When a beneficiary's payment gateway completes payment, the successful payment return code may be communicated back to the thread's return address. This option may be more network efficient, but less flexible. If the return code was received as payment-successful, the proxy server can update the patient account (e.g., via provider tables, which may be copied to insurer tables). Also any fee remittal is updated there in the insurer account table.

The risk allocation parameter can include the assigning of financial risk to a party, and the party's underlying health condition. In this example, it does not mean a priori allocating a relative mix of risk between the parties explicitly (although mix imputation to each paired party may effectively alter the mix after-the-fact). Assigning financial risk may also involve imputing the implication of a health metric, e.g. if cardiac disease is initially diagnosed, greater financial risk will ensue.

If a cardiac disease or cancer is newly found via a health metric assessment, it may affect the expense calculation for either or both the beneficiary and corporate party, by discounting it or increasing it. Or the effect may be to transfer part or all of such obligations, so that significant future financial outlays to be associated with the disease, are to be borne until the condition resolves medically, or until financials are resolved mostly or all by insurer (who is eventually in a better capital position to absorb). But it also will affect projected future liabilities for this beneficiary.

Recent remittal or credit history may be a highly-weighted factor to impute into the risk allocation parameter. If recent payments have been late, that trumps a prior stellar credit history, in other words. Then current factors such as income and debt weight in utilization. The paired employer corporation as a party may have analogous factors, e.g. revenue and net income vs an individual's salary.

If a risk allocation parameter for either party returns a degree of health or outlay risk, this may be reflected in the expense division rule. The current outlay past number of (“x”) visits' average or the last visit, may be used as a continued portion basis for the employer and the beneficiary, with any bill amount overage to assign to corporate reserves or insurer. Or the last x-visit average may be increased by some declining discount off the increased bills as future expenses occur, e.g. initially 20% of bill increase amount change for last visit relative to previous visit, plus prior x visits' portions incurred, averaged together. This adjustment may be by specialty or more likely and clean, across specialties but pertaining to such a risk condition. Any discretionary items would still be owed by beneficiary and/or employer parties as previously. The insurer's outlay cost absorption for major conditions may be contingent upon sufficient reserves, or forecasting of future accruing reserves.

If a risk allocation parameter for either party returns a degree of classified credit risk, a credit surcharge may be attributed there as an additional percentage fee (due if the adjusted bill portion is not paid in time, e.g. 30 days). Different degrees (such as red, yellow, vs green) may involve a different percent surcharge to that particular party.

Because the credit risk is presumably that of remitting the principal expense, the percent surcharge may be calculated on that expense rather than the fee curve portion (or both). Updating of the patient account is unordered with respect to the employer account. Updating of the patient account occurs before the provider's remittal account is updated.

Updating of the patient account occurs before insurer's account is updated. Akin to a credit card merchant/buyer network, the beneficiary's account default directives for payment (i.e. which credit/debit card or online payment system) have previously been forwarded upon setup into a provider's payment gateway. Ad-hoc payment methods may be supported. The gateway may also handle authentication information previously supplied by the beneficiary, e.g. card PIN.

In some embodiments, the division of expense between patient and paired employer corporation may be affected only by the health metric and/or a corporate-level negotiation of their health plan. The division may be structural, whereas credit history and income pertain to one particular party and may therefore not affect the other(s). Corporations may also re-negotiate annually, depending upon competitive offerings at that time.

If a corporation wished to promote ergonomic health, then defined improvement in that health metric may affect the split division: such that the employee incurs a defined portion less (and the corporation absorbs that cost, or negotiates with the insurer such that latter absorbs), or it is allocated to an individual or pooled savings account.

For example, an ergonomic metric may be completely “restored” to health, against a $1000 expense plus $40 in fees. Given complete restoration, the entire bill may be waived for the beneficiary and/or the corporation and therefore absorbed by insurer.

If only some improvement is observed, the fee may be waived or partially waived while the expense remains to remit. Such waiving may occur before the division. The next ergonomic bill or expense might not be waived at all, if a problematic metric arises again. In other words, the simplest form is in real-time bill matching-to-metric for waiving, depending upon the latest metric or latest metric change. (there are other forms possible also)

An insurance “plan” may translate to a form of contract, where the corporation is gaining immense upfront cost reduction in return for fulfilling later financial (and health) commitments. Such a plan specifies the division between all involved accounts. It specifies adjustment to such division under specified conditions. Ad-hoc or amended conditions or divisions may later be added, deleted or changed.

Because code can in theory reside anywhere in the payment system network, for performance reasons the expense division may occur in the provider's node following expense generation, before transmitting to each respective party's node.

The adjusted expense may be calculated from a) imputing the fee base and fee rate algorithm against the total cost, then b) subtracting (or adding) that fee amount to the total cost, then c) applying the employer percentage to such total cost in order to yield the employer-portion adjusted expense.

A bill's expense and expense division is calculated by this payment system's processors located at or bandwidth-proximate to the provider's locale. The employer bill portion can indicate the division of total bill and the items or item groups thereof, and the algorithm or calculation used to derive the employer's portion (and optionally the patient or beneficiary's portion).

A patient bill shall be generated according to the periodicity specified in contractual terms. For many, the bill is generated upon provider completion of prepared items. For other beneficiaries paired with employer groups and/or types where allowances are enabled (defined below) or for individuals opting for an allowance, bill generation occurs at the end of day or period (EOP), with prepared items accumulated since period start.

The outgoing bill has been generated there by the communications process wrapping with the target employer's node address and other network information. Once sent, it is bulk and/or stream-transmitted to such target employer's designated receiving bill communication node, where it is logged. “Designated” may mean internal for a large corporation with its own finance arm, or it may mean an acquiring bank is assisting through processing. Outgoing bills may be batched to a target employer.

Once a verification process vets the newly arrived bill(s), debit requests and fulfillment may occur. Or, with bigger employers, a reciprocal provider and/or insurer account may exist at the employer's acquiring bank (e.g. above a revenue floor). Following a bunch of employee (beneficiary) authorizations, they can sweep accumulated authorized funds at every end of daily, weekly, monthly or other period. Peer-to-peer is more robust and scalable, although more complex, than centralized in theory.

Debit completion, if successful, results in generating credit authorizations to offsetting parties' designated financial processing arms and accounts. Provider credit authorization to the provider's payment processor or gateway ensues for the amount portion. Insurer credit authorization is sent onward to insurer's payment processor or finance arm for the fee portion.

An automated employer process may extract fields using a form-based utility. Fields such as expense, employee, ID, transaction number, fee and other identifying information can output to a separate incoming receivables corporate file for accounting purposes. Insurer can supply the form-based extraction tool.

Because debit authorizations on behalf of employees or beneficiaries occur before the debiting of employer account(s), the debits may occur at EOP or other designated time, as a collective sweep. Or they may occur in real-time as an authorization is received. One account can be maintained, or one account per employee or beneficiary, or an account per some or all employee classes, divisions, groups, or departments.

Sometimes the reverse may be practical, that is, funds can be drawn up at the provider's account in advance, with corresponding net or credit-next-period at end of period. Thus, funds may be immediately available to the provider (as in theory possibly working capital vs on-demand drawdown), and may be discounted by 10-15% for this alone, as no collections personnel overhead may be needed. Thus, an advantage to the employer is potential discounts, with additives described below.

With this payment system, providers can receive payment almost immediately or the next day. By contrast, the average collection period of medical providers as of June 2018 according to a Google search, is 45.5. Days. Businesses typically charge 1.5% per month for late payments, so 45 days float may translate to 2.25% savings. Employers (and beneficiaries) may receive such a discount for early payment. An intermediate discount interpolation or pegged time:discount intervals may also be structured.

An employment processor, in some embodiments, may be separate from the bill processing payment system residing on employer's behalf, for privacy and for current-status reasons. Thus, there may be an on-demand extraction program that runs via a form definition which was previously supplied to such a program, e.g. fields delimited by tab, comma. special-field item, special-field record or line. Field order can be defined by the employer. The record definition or lines per employee can be defined by the employer. Input or output record and source may be time-stamped.

At the employer, an ongoing authorization process extracts and compiles transaction identifiers, party info, and corresponding amounts into an authorization file. The state is marked “open.” The authorization process is presumably geared to translate by comparing use of the timestamp sent since the last EOP or other designated closure of authorization period or other condition, e.g. every allotted time interval. (or a flag basis that alternatively incorporates such ‘sent since last time interval closed’ meaning)

The authorization file, if not existing for this post-EOP time period, is initialized at the designated acquiring bank's payment processor to compare against an employer settlement file there, for reconciliation in case for example a transaction is not received. As the payment processor recognizes the initialized (yet empty) authorization file, it creates a settlement leg file in ‘open’ state in its own node.

By authorizing debits to the employer's acquiring bank, settlement begins to occur. Corresponding credits can occur to the provider's proxy account local at such a bank. Or, if there is no proxy account, individual credits may be transmitted piecemeal or preferably batched. Acquirer's payment process goal may also be to subsequently match settling completion total to that employer authorization file total.

At EOD, EOP or closure period, any credit sweep to the provider occurs, netting down the local proxy account. The settlement leg ‘open’ file may be compared against the authorization ‘open’ file, to determine if the totals correspond. It's perhaps more likely to be a settlement problem than provider reversal.

A provider-based allowance account scheme is used in some provider (for a designated group or type of employers) scenarios, the more traditional above scenario in others. For the former, fewer authorization/debits may be needed and hence less system traffic. At end-of-period, a debit accounting statement by the provider's payment processor or gateway may be developed and sent to the participating employers' processor/gateway along with that of the insurer. Employers' authorization of ensuing rollovers may occur as above, after netting provider-supplied debits on behalf of each allowance-enabled employee against each employee's typical (credit) premium for period, then summing. Insurer may also contribute or drive contribution shares. Such net credit, intended for top-up of the provider account, is first authorized via a net statement for employer and/or insurer, then debited from employer and/or insurer account.

Free cash-flow positive employers (after interest payments), where wellness is valued, may first opt for an allowance arrangement with certain providers who are trusted in business practices. To set up by type, a status field may indicate such allowance employers and respective eligible employees. Only employees there designated as eligible, are those served in such top-up provider arrangements.

Large drawdowns at the provider are by beneficiary or corresponding employee, for example for cancer. Other funds earmarked to the same employer but to a different employee cannot be used to make up any provider shortfalls. To deal with potential shortfalls, an advance top-up special request can be auto-sent (if enabled in provider application preferences) to employer to request an allowance advance for the next time period, specifying a number of period-equivalent days forward until the next advance or loan period (e.g., with commensurate interest). If the employer (set in employer application preferences) were to authorize allocation from an allowance outlay reserve via an electronic form layered on a messaging in-application tracked format, then authorization auto-occurs. Otherwise manual drawdown could be transmitted from the employer, via manual debit at application level, or the insurer could facilitate.

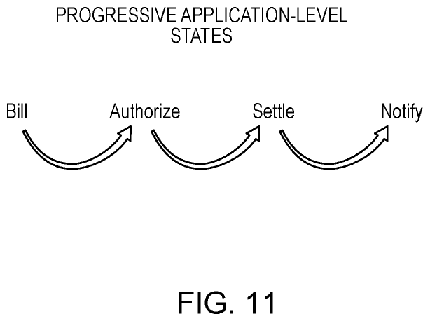

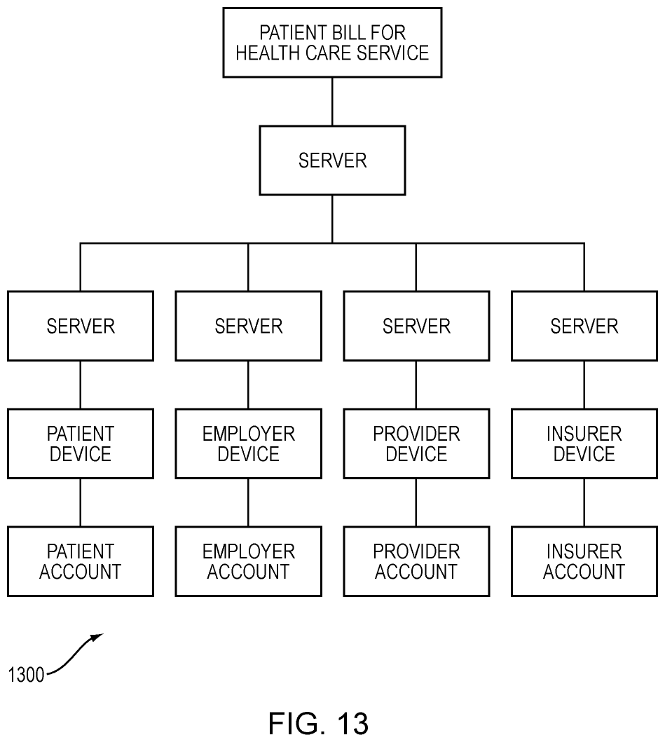

FIG. 11 is a state diagram of a billing process in one embodiment. As shown, there may be a progressive state order for normal healthcare bills and remittal: 1) billing, 2) authorization, 3) settlement, 4) notifying back. Node servers can reflect this state progression, with stateless microservices progressing state within the databases used. Thus, a node server may locate bandwidth-proximate to the provider, reflect a billing request made to the beneficiary or automated to the employer, and store the billing state in a database. Once the authorization state is invoked from billing completion as in FIG. 13 via a microservice, the authorization state is then database-stored. Context is therefore not in microservices but in databases as per state, its timestamp, and transaction ID.

Once authorization completes for a transaction, the settlement state may invoke via a microservice at the node server. Settlement invokes a payment processor or gateway, which relies on physically separate databases as a distinct set of processes. Once settlement completes (if successful) via microservice return to the node server, completion invokes the notify-back state.

Thus, state control may be driven by back-end sets of microservices at the node servers. A given node server may have active microservice threads in any state at a given time. Issuance of notifications to parties occurs via such services.

Settlement and authorization file close reconciliation can be coordinated through microservices. As an authorization thread completes, an additional service may be spawned that updates an authorization file at a payment processor incrementally.

But an average employer node may handle at most hundreds or thousands of authorizations a day, for a large company or regional subsidiary. It may be beneficial to push a settlement to the insurer's payment processor in this scenario, where by contrast thousands or more a day occur, and thus target bank identification number requests may be further batched within the period.

Discrepancies are handled first at a payment processor, if there appears less settlement number count than authorized. If converse (less likely), the issue has to be unpacked via sending a node server's database entries for reconciliation. (In the future, it may be that disparate node servers send to a far off payment processor for handling some transactions, for example)

Node servers may maintain the address tables for each party that fronts to the network. Thus a server initiating a microservice pay request to a first employer, might look up the first employer's network address there, for sending. This allows such servers to maintain the network of affiliated coordinating banks and also allows for reconfiguring flexibility as growth occurs.

Node servers communicate with and control the databases resident for that party. The authorization-related database at a processor site is distinct from the settlement database, for performance reasons. Local coordination across multiple repositories, rather than being hard-coded as invoking the next stage and state, may be driven by table-specified microservice invocation. That way, it may be changed in the future if more granularity is needed or a rearrangement of steps. Less “top-down” global coordination may improve performance and robustness. Access to a repository is through its node server.

The insurer receives a visual, parse-capable facsimile of the expense portion of the bill, with portions earmarked for remittal respectively by the beneficiary and by any paired employer. The employer portion shows by-item attributed breakdown of principal and fee. (Any beneficiary portion shows by-item attributed breakdown of principal and fee.)

Therefore, once the employer portion is debited, a credit process initiates for the fee portion to the insurer, along with crediting the provider for the remainder. Two credits occur for one debit. The adjusted expense may be defined as the attributable principal portion adjusted by the attributable fee portion.

But, considering how to structure the beneficiary portion, then the employer portion as expense climbs, then the insurer portion as expense magnitude climbs further, may lead to calling the division structure into question. If the beneficiary pays, for example, 40% (because no upfront premium burden), they may conclude, over time, that they are over-paying for their services. Also, employers pay on average $6K/year and individuals pay $1.2 k/year, which presumably covers the vast majority of medical costs when aggregated per year, or insurance carriers may not make money. The medical expenditure curve details 15% of total healthcare costs for 80% of the general population. Even near the end of life, costs hover around (only) $5,000/year when a patient is in a non-terminal year, escalating on average to $45K in the final year of life, which is a small segment of a broad population.

This may lead to a solution that asks the beneficiary to pay a low fixed copay per visit (set a priori at somewhere in $0-99 range), the employer pays the remainder up to a set amount which effectively sets as an equivalent average yearly outlay under the current system (and grows annually as CPI or some healthcare index), and insurer pays the rest. (The low fixed individual cost or visit number grant as elsewhere, may discourage unnecessary visits.) Over time, with fee accumulation building up financial reserves, there may be enough profits in the system, if widely adopted, to lower fixed costs and even employer costs.

When fixed and annualized costs are overcome (including insurer's running-forecasted contribution to billed outlays larger than employer and beneficiary pay share), remainder profits may be designated as a “reserve.” The reserve may be annually apportioned between insurer half (to build shareholders' equity against future costs as population increases) and participating corporations' half, such that each corporation receives a percentage from the corporate reserve proportional to its annual participating outlay (relative to other participating corporations), rather than a per-capita multiplier that tracks sicker vs less sick populations less well, to be credited back according to last year's outlays. Cases where insurance transaction fees may be dropped or altered include hardship, end-stage life care and hospice, or by corporate negotiation.

The provider may designate such fee-change cases. Rather than manually designating, which may not scale, it may be more beneficial to check for death status and retroactively credit selected services. Thus, OCR on bill content itemization (which the system is performing anyway as elsewhere), can search for end-of-life terminology.

For financial hardship of a party, the original credit check will presumably provide data against some (regional cost of living) threshold. A party flag may be set, and may be revisited annually. These rules may apply uniformly with respect to each patient and plan, as per pricing fairness.

There may be timing interplay between each respective payment-party-type account (beneficiary, employer), and a provider account. The former may occur so that the latter can then be remitted. There may not be timing interplay between payment-party-type accounts themselves, if such debits occur successfully. Between a beneficiary and paired employer's accounts, as approved in advance and if debits transact well, in other words there may be no interplay.

By contrast, if beneficiary debits fail or if a paired employer's debits fail, then the other party (and provider) may be notified in an increasing escalation. For example, if a first fail leads to a notification, a further fail may lead to a freeze advisory regarding future provider services, and a still further fail may lead to a notification of termination of that party from payment system etc. The beneficiary may not be assigned obligations of the employer, nor vice versa, although any employer-continued defaults may effectively either remove employees from the payment system, or may first cause them to experience an option to renew on their own (e.g., at 100% obligation).

When payment is made to the insurer's acquiring bank's account from beneficiary or employer on behalf of the provider, then notice can be batched for End of Period. (The provider can be paid quickly, which may be as soon as the next business day in other words, or even the same business day if a provider account were maintained at acquirer or in an allowance scenario.) Upon parsing such notice, insurer can update the party accounts across the network. Partial payment in this context might mean payment of some bill portions, but not all. In some embodiments, this may not mean more fine-grained partial payment of a singular item, such that partial “collection” is performed. That may mean that the insurer may issue partial debits which were not authorized by the provider, and may try to perform a collection agency function.

Beyond the notice which provides a physical, auditable trace of the debit, the debit itself is performed via the acquirer's processor, via the microservice thread involved in such debiting. Upon completion, a following microservice thread is invoked to credit the corresponding provider account, then another to credit the insurer account. Upon completion of the former, an ensuing microservice is invoked for notifying the debit party (employer or beneficiary).

Successful commits can occur subsequent to settlement concluding successfully. When a transaction's debit(s) and credit(s) respectively return successfully, then commit commands can issue to the associated server fronting such databases. One purpose of this is to delay actual entry writing of a journal credit entry in an account until other necessary components have also returned successfully, i.e., the corresponding debit entry. Otherwise, some party might receive funds without the requisite funds being withdrawn to actually pay such. (Insurer may then have to absorb).

Ordering in time occurs, such that debit commit microservice(s) take place, and if successful, then the corresponding credit commit microservice(s). For a given party and bill, debits (or credits) or groups may be “packaged” as one, in order to conserve bandwidth and security overhead. (Likely there is ordering of larger or more principal debit items before smaller or ancillary items, as well.)

In a settlement method, a party's node server executes a debit row lock for party funds. Since previously authorized, commit for those funds occurs. Likely funds authorization previously earmarked debit-to-be-funded from a party row, such that a later commit actually performs the debit. Otherwise, authorization may have to be in a separate table, with later update to authorization funds after commit, which is a risk if somehow the update were lost.

One goal is to treat the transaction in total, thus coordinating either a successful conclusion or a need to undo micro aspects that might have previously been executed. For example, if a reserve were taken for an ensuing debit, but the debit then fails, then that transaction may need to be undone.

The effect may be that of some expense items in a bill being rolled back while others commit fully. For example, several high-ticket surgery items may complete drawdown and corresponding payment to the provider, while ensuing items may fail due to lack of sufficient funds at the time.

Failure actions in this case may range from: no-recourse failure, to retry at some designated interval, to sending message (s) to parties for requesting adjusted limits, and/or penalty/interest charges that will apply within a designated number of days if not paid.

There may be systematic tracking of a party's pay history, such that multiple non-remittals increasingly trigger an alert to the provider and/or employer. Also, there may arise systematic tracking in the unlikely event a corporation increasingly over time does not remit, with alerts to the provider and insurer.

It may be that, rather than submit each “transaction” in a bill for authorization separately, it may be more efficient to first try all together as a sum, against the party's authorization limit. If that were to fail, trying each separately at that stage may be a recourse.

Whether separately or in toto, each stage of microservice advancement may have a corresponding error result or graded results. Ordinarily each stage, if resulting in a positive return, triggers an event which is recognized purely by the next progressing microservice.

Conversely, if an error is encountered by any microservice stage method, an analogous error event is triggered. That event is recognized purely by a corresponding error handler. Different error handlers exist for different processing stages. Thus, error handling can be fine-grained and specific to each stage.

If a pay card is within the bank's card On-us brand network: a) authentication, b) sufficient cardholder funds, and c) valid card not blocked and before expiry are checked by the bank. If good, the bank sends authorization back to the gateway. If the debit or credit card is not within the bank's card network, the acquiring bank passes necessary information to the card network, e.g. extracting the first 6 digits of card number for the issuing bank and network. (Bank Identification Number or BIN)

The network identifies the BIN, and routes to the issuing bank. That bank checks a) authentication, b) sufficient cardholder funds, and c) valid card not blocked and before expiry. Once all validated, the bank approves by authorizing, and sends back authorization via the card network to the acquiring bank. Also in this case, the acquiring bank may forward authorization to the provider's processing gateway.

At End of Period, the processing gateway batches transactions done during the day, and forwards to the acquiring bank for reconciliation. (For example, if the number of transactions does not equal the number of authorizations.) If reconciliation by comparison to the acquiring bank's authorizations for that provider matches up, then a “Match/Close” message is sent to both parties. Once that occurs and the number of transactions match, the acquiring bank credits the provider's account while starting the card network settlement process.

The acquiring bank generates a settlement file for each credit/debit card network, using the BIN numbers previously processed during the authorization stage. A card network breaks these down into clearing files for individual BINs, (i.e., each issuing bank). For a patient/beneficiary, the network has debited the card issuer bank while crediting the acquiring bank (after netting positions). Update of the patient account may happen independently with respect to the updating of the corporate account. (Update of a corporate account happens before the corresponding update at insurer's account.)

Rather than licensing from elsewhere, the insurer may create a password or double-key layer to log in to a party device or account (e.g. where a sent code must also be entered by the recipient to confirm a profile). Because it is financial in nature, it may be beneficial to implement the latter, where the first key is a strong password-based and the second is a trusted device-based supplied code.

Secure Sockets Layer (SSL) provides a stream level point-to-point security in communications. Beyond that, some necessary layering framework on top of communications is necessary to safeguard transaction credit card payments, debits, and/or other payment services. Also, some means of relating such payments to actual bill sub-item(s) may need to be made, in the event that questions arise or forensic accounting is needed.

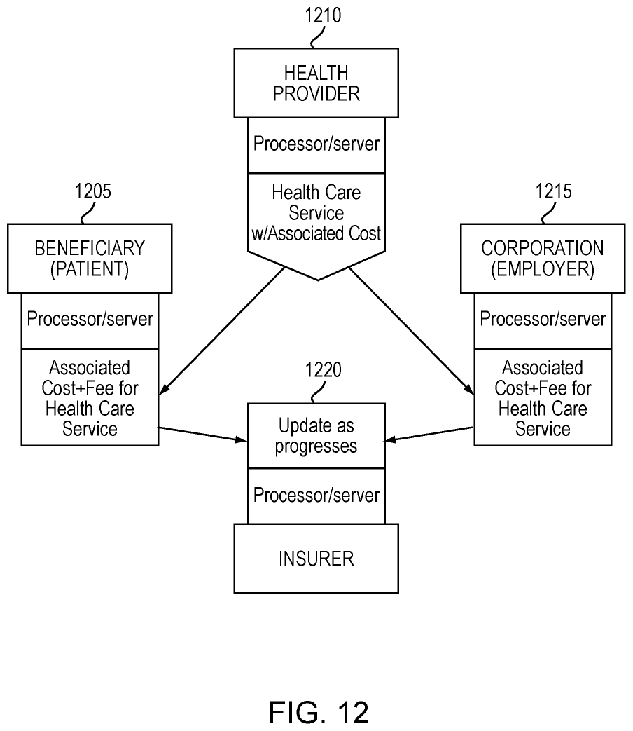

FIG. 12 is a flow diagram illustrating communication among parties, including a beneficiary (i.e., patient) 1205, health care provider 1210, corporation (i.e., employer) 1215, and insurer 1220 during processing of a bill for health care services in one embodiment. An insurance parameter may provide a way to determine whether a patient's health is being improved through delivery of a service. The parameter can reflect relative change since the last parameter value, or an absolute metric particularly at the start if it has not been prior-evaluated. If such a parameter is classified as “poor,” it may result in a full fee amount being imputed. If instead classified as “good” or “adequate,” then the fee amount may be decreased (or optionally imputed as negative). These gradation buckets may be more fine-grained, where “superlative” improvement may result in negative imputing, in effective deduction against principal (i.e. provider expense). For a heart ailment for example, if a specialty metric parameter stayed unchanged when assessed at end of visit, the fee percentage may remain as-is.

If the metric improved enough to be classified as good, then the fee percentage may adjust downward as a “reward” for a job well done. If metric improved enough to be superlative, then a fee percentage plus base goes to zero or even effectively negative. In the latter case, the insurer may make up the difference to the provider or offer other perks, as rewarding a provider that performs well. Typically, providers may have approximately 10-15% administration overhead. If the metric were to downgrade, then, if systematically seen across patients from such provider, the fee may be increased as a deterrent.

The metric parameter may be a sampling of a moment in time. Yet, patients improve or downgrade in the course of time, which may be longer time than a single visit. Thus, example embodiments may utilize a mechanism for either sampling again at interim, or use a metric at the beginning of the next visit to “interpolate” the change. Further, an auto-associated credit-back (or additional debit) adjustment may be needed to reflect such a parameter change. Over time, such metric sampling and fee adjustments may even be performed daily.

A $1,000 cardiac bill might incur, for example, $49 in service fees initially. This sample rate or percentage is higher than the 1-2% that credit card issuers might charge. But as bypassing upfront monthly healthcare premiums constitutes a substantial ongoing savings to a corporation or individual, this higher fee may be beneficial. It may then be advantageous for the employer to absorb all service fees through a defined number of visits (per specialty, because other ailments or checkups may be needed) to expire annually, in the paired individual/employer scenario.

For this $1,000 bill, the bill portion incurred by the beneficiary may start after a granted number of annual visits, or number per specialty (in the paired employer case) to discourage excessive unproductive visits. That portion may be renamed, e.g. co-pay, co-service fee. (Rather than pass-through the exact fee at that x+1th visit to the beneficiary, better to ramp up the division of such amount programmatically as it may increase over time and future visits. Just strictly secondarily, a sudden transfer from the employer to beneficiary (i.e., patient) may be discontinuous at that stage.)

If a service fee is based upon more value-based pricing, then moving towards a percentage, but soft-capping the fee at high end may balance the middle. For example, at 5% on a $10,000 bill (or item or group) a service fee may be capped at $499. Alternatively, the service fee may be based upon the cost of processing a transaction, where if cost-based the fee curve may be flat with steps vs percentage-based (although less money may be made in given employer:employee set). A fee curve may also incorporate past period transaction volume, either by provider, by beneficiary, or by employer or combination thereof.

The number of visits (per medical specialty) may become a factor when too many non-productive visits are made. Thus, the fee may become a blend of above, plus a multiplier on a number of non-productive visits beyond a given number. Because resulting medical productivity can be assessed by metric, but only after the fact, this factor may be a lagging calculation.

The employer may pay bill items and fees up to a “specialty” cost grant cap, upon which a division with the insurer then commences. An employer/insurer division (above specialty cap) may be cleanest to then run at a flat percentage. Very few employer cases may run in the millions of US dollars, at most likely in hundreds of thousands for a cancer case. Such magnitude may not be problematic for a large or medium-sized employer.

FIG. 13 is a block diagram of a network 1300 in which example embodiments may be implemented. Rather than a provider's server talking directly to a party's device, server-to-server communication may be implemented. A notification of health care service administered to a patient is sent from the provider to the primary node for the employer, patient and/or insurer. It can be sent by electronic means, fax, or by physical mail. Such documentation may be parsed automatically if by electronic means, or by the pay network application's OCR input scan if fax or by physical means. Alternatively, the provider can submit a furnished electronic-form (with pre-designed insurer format to make easier) that when filled out, equivalently specifies such notification. The system operates via queues, wherein an incoming service notification triggers an Incoming Service Notification event.

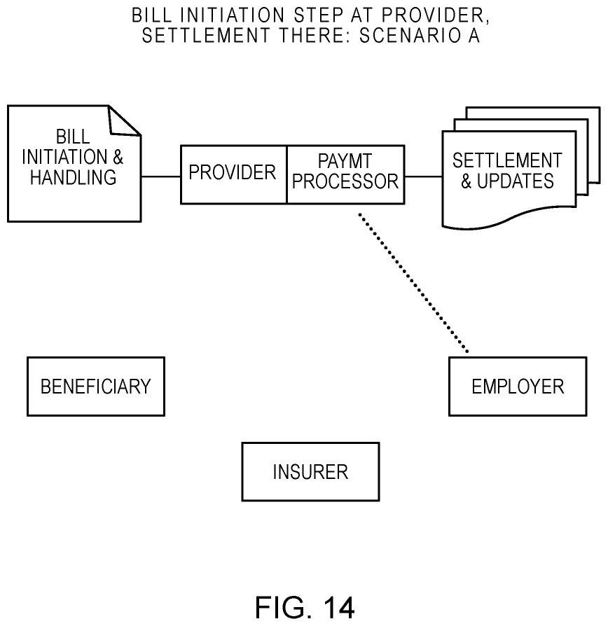

FIG. 14 is a state diagram of a process of bill initiation in one embodiment, showing the major steps of bill initiation (e.g. “handling” abstracts some type of authorization) and subsequent payment/remittal. Processing may not be balanced amongst the four parties belonging to the network.

A table entry at the provider may indicate, for a given employer, whether in some scenarios (apart from an allowance scenario) a settlement will drive from the provider's acquirer/payment processor or from the employer's acquirer/payment processor if it exists. A very large employer (e.g., with tens of thousands of employees), might reasonably regionally employ a payment processor to presumably better control and lower their per-transaction payment processing fees. As these are corporate payments rather than retail-level, card processing costs can be avoided and direct pay processor debiting of acquiring bank corporate accounts can occur. Still, likely some new type of interchange fees may be assessed by such bank, negotiated in advance with the corporation and the insurer.

A direct-settling employer might also opt to handle settling for some or all of its employees' bill portion as well. This may mean that employer:employee settle table data may need to exist at a provider for the employee or beneficiary bill initiation step. Companies may have chosen to authorize a specific provider for drawdown immediately and automatically following bill completion. Confirmed account drawdowns with corresponding bill itemization may be sent to the employer. Then at period end, advancing of funds occurs back to respectively top up such accounts from the employer.

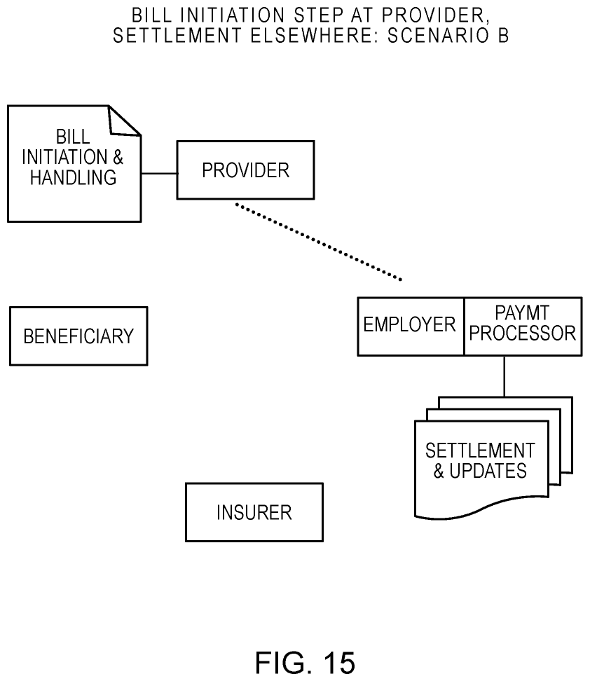

FIG. 15 is a state diagram of a process of implementing a payment processor in one embodiment. In the scenario illustrated, a larger company opts to settle some or all employees' healthcare portions via a payment processor. Larger companies may choose to use their own payment processor for their settling (and perhaps for their employees).

Canned processor interfaces may be supplied to corporations, for filling electronic forms to connect to their direct debit accounts via the acquiring bank. This approach standardizes interfaces, provides more homegrown security, and allows possible interchange fees, at startup cost of distracting from health metrics. It also may facilitate eliminating employee settle table data at the provider (as above), if every participating employee were granted a certain number of doctor visits annually before any co-pay were incurred. (This may roughly amount to equivalence with today's upfront employer cost for annualized premiums, and thus effectively amount to a net transfer of corporate obligations from fixed in front-end time, to as-incurred in real-time. Corporate liabilities effectively cross-transfer as well, via insurer's payouts.) Any number beyond that number of medical visits would then be increasing the co-pay amount (for discouraging frivolous numbers of visits), perhaps deducted from their paycheck.

For employers small enough not to warrant a dedicated pay processor, since assessing creditworthiness upfront anyway, there's arguably a basis for creating a direct health pay “brand” from scratch where drawing from designated corporate bank accounts and employee salaries (as for healthcare premiums today). In this small employer scenario, as eventually with self-employed individuals and retirees, credit card payments may be available as a secondary option. If so, a markup “discount fee” may be calculated by adding card interchange fee to the usual fee, and applied.

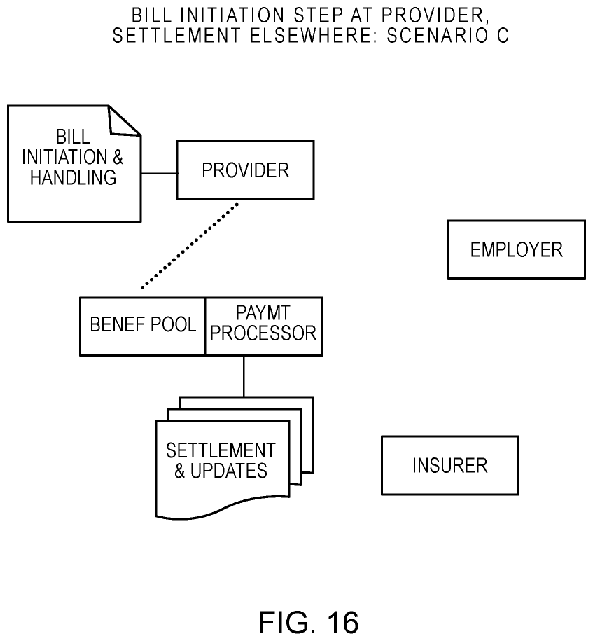

FIG. 16 is a state diagram of processing healthcare remittals for self-employed or retired individuals, illustrating how, over time, a pool of self-employed and retired individuals and/or families may opt to participate in processing healthcare remittals. Beneficiary pools may be created (with or without an employer) to use their own payment processor.

In the eventual self-employed individuals and retiree scenario, such individuals may be obligated to contribute beyond the co-pay or division amounts plus fees that other, employed individuals pay. Otherwise, the insurer may have to cover the large remainders owing to providers. Thus effectively, prior corporate contributions via fees on total payment volume may have to be utilized from coffers, in addition to fees garnered.

Assets

Assets may be classed as: insurer's tables and data, payment system network, metrics, and pay card. Among credit card issuers, biannual fees are assessed for dues to belong to the payment network. At a lower rate than interchange fees, such might be on the fee curve for volume, card type, any international usage etc. In this case, unlike those issuers, fees may be assessed in both directions, e.g. to providers as well as beneficiaries and employers. The rate may vary by party type.

Although the cost for implementing metrics may be incurred upfront, it may be beneficial not to assess biannually until somewhat accepted among providers or key influencers. Conversely, assessing biannual usage toll when early may be a way to elicit buy-in level, as providers with strong records may be glad for differentiation. Also assessable in both directions, the rate may vary by party type, volume, severity level (which proxies for value), etc.

Liabilities

Current and projected liabilities may be runtime-executed for each party, party's employer, group, and/or the provider's customers. Each party may require a declaration in a base currency, with programmable variable-set algorithm or form weighting for projected future outlay streams. Because achieving adequate takeoff funds needs to scale, running liabilities manages the runway operational outlay risk during the initial phase.

Financial Reserves

Until the insurer builds up sufficient reserves to debit against significant aggregate beneficiary care outlay events, a corporation may reserve funds in order to enter the payment system. The reserve amount may be proportional to the number of people covered, since financial risk runs as such. Reserves are renewed and adjusted annually, until or in inverse proportion to insurer buildup of sufficient financial reserves.

Cross-risk with respect to any particular company reserves the first few years may be considered, marking for example a 1:1 correspondence for projected respective outlays or even pooling into a stake. Reserve apportionment may be pegged to specific parties only when a priori authorized and as needed at advance cost. Such funds may either draw from a separate designated corporate reserve account or designated corporate sub-account for the beneficiary.

Contract, Setup, Reconciliation Automation

There may be a utility provided for employers to put in some of the required information, such as a runtime requestor for employee contact info (which can reside elsewhere at the employer but be accessible programmatically when needed). Insurer uses a runtime utility to enter account limits per employer, which are presented in printed form to such employer, based upon the current specified number of employees. Any change constitutes amending the contract and the utility updates account limits accordingly.

To set up any new node server and database(s), there may be a runtime utility that automates table definition, creation, and ensuing population. There may also be performance monitors for throughput, scaling etc. There may be an auto-setup executable for the provider gateway or processor too, rather than relying on third parties, because network interplay is strategic and more secure.

There may be an End of Day/Period set of facilities that can be run online or offline. These may include reconciliation reporting of payments by party, incoming funds by party, and item-level and grouped debits/credits. Receivables reporting is also useful, to note any delays, also currency exposures, backup and restore, shut down and restart by node or processor, and parallel test mode for selected nodes, processors, and/or parties.

An employer:insurer contract is auto-setup via installing existing employees and providers. If an existing beneficiary or employee were to engage a new provider, recompensing that provider is covered by the existing employer contract. As however the provider's bill is not yet automated in the payment system (e.g. as for a newly engaged chiropractor), the pay system recognizes this not-in-system status. The pay system then engages OCR to read the bill's content, create the proper table entries for auto-adding of a new provider, and then proceeds to automate payment.

Thus, ad-hoc addition/deletion of employees, providers and even occasionally employers is supported by the system. Employee add, delete, or modify can be handled ad-hoc from the employer's secure server. Ad-hoc addition, deletion or modification of employers can be handled from the insurer's secure server. Ad-hoc deletion of providers can be handled via a reconciliation End of Day/Period utility that crawls to look for any unused providers over some specified time period.

There may be multiple insurer servers across a geographical region or regions. There may be multiple same-employer servers (e.g., by division or corporate group), as well as multiple division, group and/or specialties for same-provider servers. The insurer may need to determine projected liability or actual outlay rollup by employer, across servers, divisions, groups, specialties, etc. The End of Day/Period utility may yield reporting or online comparison of such against contract limits for a designated time period.

Further, the insurer may determine projected cross-liabilities relative to each of its server and/or outlay accounts (i.e., across employers in such server cluster). If projected liabilities outstrip available accruing reserve funds in one server and/or outlay account location (for a designated time period) by a defined margin, the insurer may need to transfer funds from another where such funds outweigh projected liabilities there (for a same or different time period) by a same or different margin. Both server liability rollup and reserve funds transfer may be implemented as End of Day/Period utilities with security and funds logging.

Although the provider may also be multi-server and used by the same beneficiary for escalated services at a different location, ad-hoc or simply existing provider server accounts may handle such. (i.e., responsibility of a multi-account/site provider to track in their own systems for cross-purposes.)

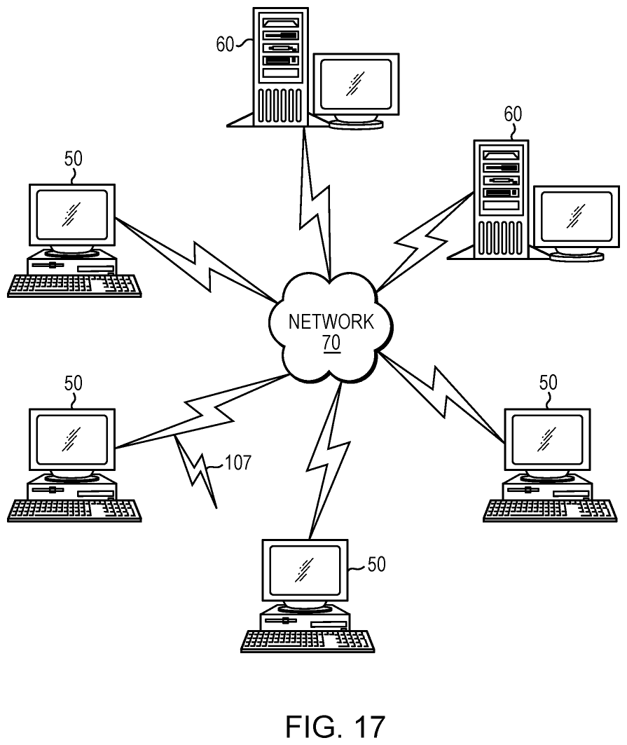

FIG. 17 illustrates a computer network or similar digital processing environment in which example embodiments may be implemented. Client computer(s)/devices 50 and server computer(s) 60 provide processing, storage, and input/output devices executing application programs and the like. Client computer(s)/devices 50 can also be linked through communications network 70 to other computing devices, including other client devices/processes 50 and server computer(s) 60. Communications network 70 can be part of a remote access network, a global network (e.g., the Internet), a worldwide collection of computers, Local area or Wide area networks, and gateways that currently use respective protocols (TCP/IP, Bluetooth, etc.) to communicate with one another. Other electronic device/computer network architectures are suitable.

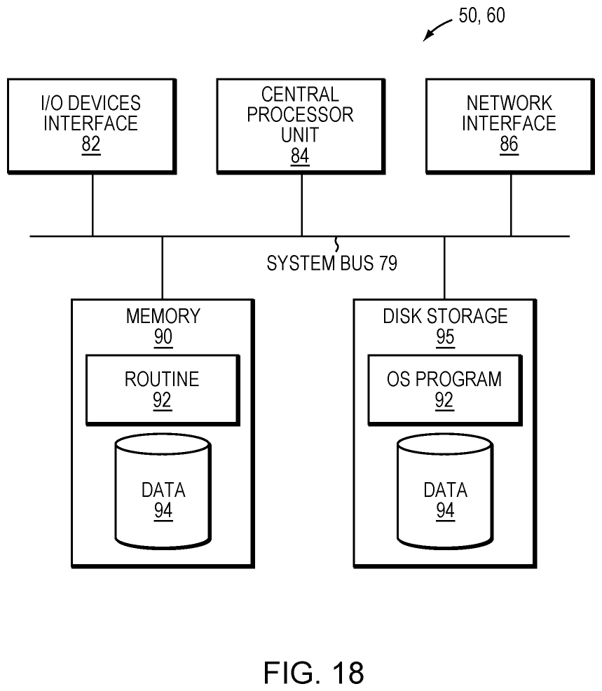

FIG. 18 is a diagram of the internal structure of a computer (e.g., client processor/device 50 or server computers 60) in the computer system of FIG. 17. Each computer 50, 60 contains system bus 79, where a bus is a set of hardware lines used for data transfer among the components of a computer or processing system. Bus 79 is essentially a shared conduit that connects different elements of a computer system (e.g., processor, disk storage, memory, input/output ports, network ports, etc.) that enables the transfer of information between the elements. Attached to system bus 79 is I/O device interface 82 for connecting various input and output devices (e.g., keyboard, mouse, displays, printers, speakers, etc.) to the computer 50, 60. Network interface 86 allows the computer to connect to various other devices attached to a network (e.g., network 70 or networks 100, 170, 1300 in FIGS. 1 and 13). Memory 90 provides volatile storage for computer software instructions 92 and data 94 used to implement an embodiment of the present invention (e.g., code detailed above). Disk storage 95 provides non-volatile storage for computer software instructions 92 and data 94 used to implement an embodiment of the present invention. Central processor unit 84 is also attached to system bus 79 and provides for the execution of computer instructions.

In one embodiment, the processor routines 92 and data 94 are a computer program product (generally referenced 92), including a computer readable medium (e.g., a removable storage medium such as one or more DVD-ROM's, CD-ROM's, diskettes, tapes, etc.) that provides at least a portion of the software instructions for the invention system. Computer program product 92 can be installed by any suitable software installation procedure, as is well known in the art. In another embodiment, at least a portion of the software instructions may also be downloaded over a cable, communication and/or wireless connection.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer.

While example embodiments have been particularly shown and described, it will be understood by those skilled in the art that various changes in form and details may be made therein without departing from the scope of the embodiments encompassed by the appended claims.

What is claimed is:

1. A computer-implemented method of processing a payment for administration of health care, comprising:
parsing a notification of a health care service administered to a patient, the notification identifying the patient and at least one expense associated with the health care service, the parsing being implemented by a digital processor;
adjusting the at least one expense by a fee derived from at least one of a base and a percentage via an insurance plan parameter to generate at least one adjusted expense, the adjusting being responsively performed by the digital processor;
automatically determining, based on the at least one adjusted expense and on a parameter defined by the patient's insurance plan, a division of the at least one expense among a patient account and an employer account, results of said determining including a patient portion of the at least one adjusted expense and an employer portion of the at least one adjusted expense;
transmitting a representation of a patient bill to a patient device, the patient bill indicating the patient portion resulting from the determined division of the at least one adjusted expense, said transmitting being automatically performed by a server; and
automatically updating the patient account in response to receipt of payment of the patient portion indicated on the patient bill.

2. The method of claim 1, wherein determining the division of the at least one expense is a function of a risk allocation parameter.

3. The method of claim 1, wherein updating the patient account is automatically reconciled via electronic pay request and authorization.

4. The method of claim 1, wherein the division is determined as a function of patient risk factors including at least one of credit history, income, and underlying health conditions of the patient.

5. The method of claim 1, further comprising automatically determining, based on the at least one expense and on a parameter defined by the patient's insurance plan, a three-way division of the at least one expense among a patient account, an employer account, and an insurer account.

6. The method of claim 1, further comprising automatically transmitting a representation of an employer bill to an employer device, the employer bill indicating the employer portion resulting from the determined division of the at least one adjusted expense.

7. The method of claim 1, further comprising automatically updating the employer account in response to receipt of payment of the employer portion, via the employer's payment processor or gateway.

8. The method of claim 1, further comprising opening a distributed order of transactions across patient, employer, provider and insurer devices and accounts, and globally coordinating the local transactions across multiple repositories.

9. The method of claim 1, further comprising automatically transmitting a representation of the patient bill to an insurer device, the patient bill indicating the patient portion resulting from the determined division of the at least one adjusted expense.

10. The method of claim 1, further comprising automatically updating an insurer account in response to receipt of payment of any insurer portion resulting from the determined division of the at least one adjusted expense, via the insurer's payment processor or gateway.

11. The method of claim 1, further comprising automatically updating the provider account, via a payment processor or gateway, to indicate a payment by at least one of the employer and an insurer.

12. The method of claim 1, further comprising closing global coordination with successful commits, or rolling back all or some transactions.

13. The method of claim 1, wherein the payment of the patient portion of the patient bill is via the patient device.

14. The method of claim 1, further comprising:
enabling access to the patient account via the employer account; and
wherein the payment of the patient portion of the patient bill is via an employer device.

15. The method of claim 1, wherein the payment of the patient portion of the patient bill includes withdrawing funds from an allowance account funded by the employer account.

16. A computer-readable medium storing instructions that, when executed by a computer, cause the computer to:
parse a notification of a health care service administered to a patient, the notification identifying the patient and at least one expense associated with the health care service;
adjust the expense by a fee derived from at least one of a base and a percentage via an insurance plan parameter;
automatically determine, based on the at least one expense and on a parameter defined by the patient's insurance plan, a division of the at least one expense among a patient account, and an employer account, results of said determining including a patient portion of the at least one adjusted expense and an employer portion;
transmit a representation of a patient bill to a patient device, the patient bill indicating the patient portion resulting from the determined division of the at least one adjusted expense, said transmitting being automatically performed by a server; and
automatically update the patient account in response to receipt of payment of the patient portion indicated on the patient bill.

17. The computer-readable medium of claim 16, wherein determining the division of the at least one expense is a function of a risk allocation parameter.

18. The computer-readable medium of claim 16, wherein updating the patient account is automatically reconciled via electronic pay request and authorization.

19. The computer-readable medium of claim 16, wherein the division is determined as a function of patient risk factors including at least one of credit history, income, and underlying health conditions of the patient.

20. The computer-readable medium of claim 16, wherein the instructions further cause the computer to automatically determine, based on the at least one expense and on a parameter defined by the patient's insurance plan, a three-way division of the at least one expense among a patient account, an employer account, and an insurer account.

21. The computer-readable medium of claim 16, wherein the instructions further cause the computer to automatically transmit a representation of an employer bill to an employer device, the employer bill indicating the employer portion resulting from the determined division of the at least one adjusted expense.
